(19) United States
(12) Patent Application Publication
(10) Pub. No.: US 2009/0231281 A1
(43) Pub. Date: Sep. 17, 2009

(54) MULTI-TOUCH VIRTUAL KEYBOARD

(75) Inventors: Chris Whytock, Seattle, WA (US); Derek Sunday, Renton, WA (US); Carlos Pessoa, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/046,429

(22) Filed: Mar. 11, 2008

(51) Int. Cl. G06F 3/02

(52) U.S. Cl. 345/168; 345/173

(57) ABSTRACT

A computing system includes a display and a sensor to detect multi-touch input at the display. The computing system further includes a processing subsystem operatively connected to the display and the sensor and computer-readable media operatively connected to the processing subsystem and including instructions executable by the processing subsystem. Such instructions cause the display to present a virtual keyboard image, the virtual keyboard image including a primary key and a modifier key. Such instructions also translate touch input at only the primary key into a first keyboard message and translate temporally overlapping touch input at both the primary key and the modifier key into a second keyboard message, different than the first keyboard message.

### BACKGROUND

A computing system may provide a user with one or more mechanisms for receiving information from the computing system and one or more mechanisms for providing information to the computing system. As an example, information can be input to the computing system from a user with a mouse, track ball, writing tablet, keyboard, or other input mechanism. Furthermore, information can be output by the computer system to a user with a display screen, speakers, or other output mechanism.

The user experience provided by a computing system can be affected by the ease with which a user is able to provide the computing system with input and receive output from the computing system. In general, as the input and output processes become more transparent to the user, the user experience improves. In particular, well designed input and output systems allow new users to quickly master the input and output processes. However, in addition to being easy to learn, good input and output mechanisms do not handcuff advanced users from interacting with the computing system in a more advanced manner.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

The following Detailed Description describes a multi-touch virtual keyboard. The multi-touch virtual keyboard can be displayed by a computing system, thus providing information to a user. The multi-touch virtual keyboard is also used to facilitate touch input from a user, so that the user can provide the computing system with information. The multi-touch virtual keyboard includes two or more different keys, including at least one primary key and at least one modifier key. Each key of the multi-touch virtual keyboard is capable of receiving touch input by a user, and translating the touch input from the user into keyboard messages that can be used to pass information to various different aspects of a computing system. Touch input at only the primary key can be translated into a first keyboard message, and touch input at both the primary key and the modifier key can be translated into a second keyboard message, different than the first keyboard message.

### BRIEF DESCRIPTION OF THE DRAWINGS

FIG. 1 shows an application window image displayed according to an embodiment of the present disclosure.

FIG. 2 shows a virtual keyboard image receiving a touch input according to an embodiment of the present disclosure.

FIG. 3 shows the virtual keyboard image of FIG. 2 receiving multi-touch inputs according to an embodiment of the present disclosure.

FIG. 4 shows two application window images and two virtual keyboard images, each virtual keyboard image receiving multi-touch inputs according to an embodiment of the present disclosure.

FIG. 5 shows a process flow of a method for receiving and processing multi-touch virtual keyboard input.

FIG. 6 shows an embodiment of a multi-touch surface computing system according to the present disclosure.

FIG. 7 shows a schematic diagram of another embodiment of a multi-touch surface computing system according to the present disclosure.

FIG. 8 shows a schematic diagram of yet another embodiment of a multi-touch surface computing system according to the present disclosure.

### DETAILED DESCRIPTION

The present disclosure is directed to virtual keyboards for use with multi-touch computing systems. As a non-limiting example, a virtual keyboard image can be displayed by a multi-touch computing system. The multi-touch computing system can process multi-touch inputs to the virtual keyboard image. The capacity to process multi-touch inputs may allow for a more natural and intuitive user experience as the operation of the virtual keyboard image may more closely resemble the operation of a standard, non-virtual keyboard.

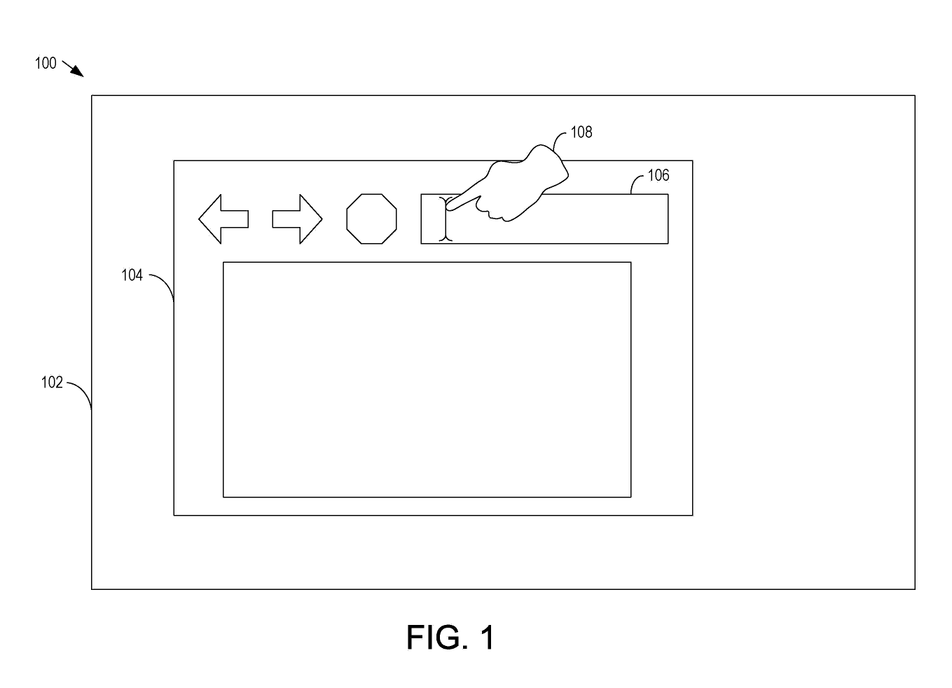

FIG. 1 shows a multi-touch computing system 100 capable of displaying a virtual keyboard. Application window image 104 may be displayed at display surface 102. As illustrated in FIG. 1, display surface 102 may receive a touch input 108 (as schematically represented by the outline of a hand with a pointing index finger). In this example, a touch input is received at an area of display surface 102 that has an application window image 104 displayed thereon. More specifically, touch input 108 may be received at a text box 106 of application window image 104. Touch input 108 may cause multi-touch computing system 100 to display a virtual keyboard image and to provide virtual keyboard functionality to application window image 104.

Although shown in FIG. 1 as a text box, other functional images may receive touch input that may result in multi-touch computing system 100 displaying a virtual keyboard image at display surface 102. For example, other graphical user interface elements included within an application window image may also receive touch input that can result in multi-touch computing system 100 displaying a virtual keyboard image at display surface 102. Non-limiting examples of other graphical user interface elements include icons and hyperlinks.

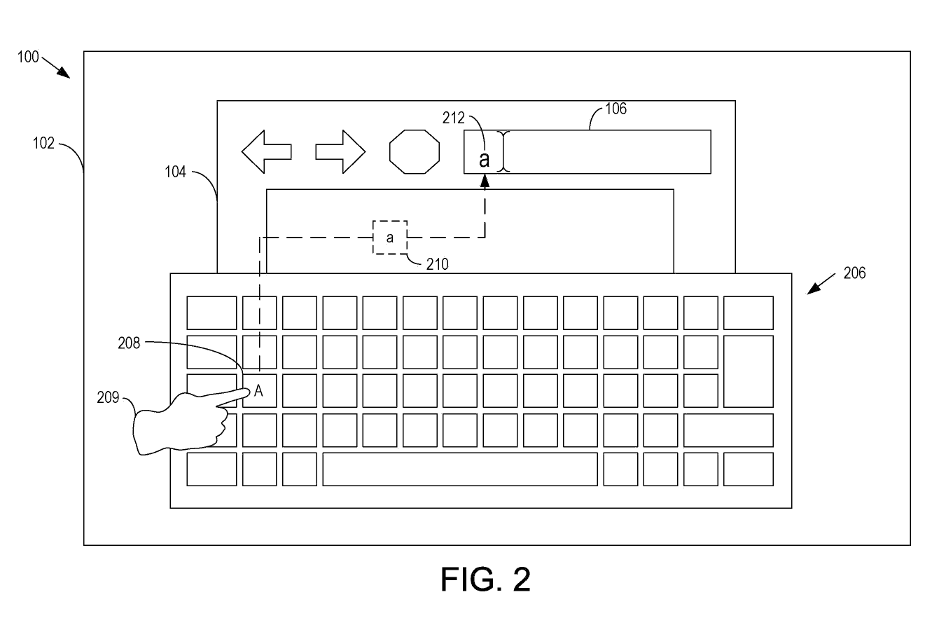

FIG. 2 shows a virtual keyboard image 206 at display surface 102. In this example, virtual keyboard image 206 overlays application window image 104. In other embodiments, virtual keyboard image 206 may overlay a greater or lesser amount of application window image 104. In other embodiments, virtual keyboard image 206 may not overlay application window image 104. Furthermore, a system user may move (e.g., via touch input) virtual keyboard image 206 and/or application window image 104 to different locations and/or orientations on display surface 102. Additionally, keyboard output produced by multi-touch computing system 100 may be utilized in different ways by various applications. As non-limiting examples, system applications, internet applications, word processing applications, spreadsheet applications, and email applications may utilize the keyboard output produced by multi-touch computing system 100.

As illustrated, a touch input 209 may be applied to a primary key 208 of virtual keyboard image 206. In response thereto, multi-touch computing system 100 may translate the touch input received at the primary key into a first keyboard message 210. A keyboard output 212 may then be displayed at display surface 102 as a text character within text box 106 of application window image 104.

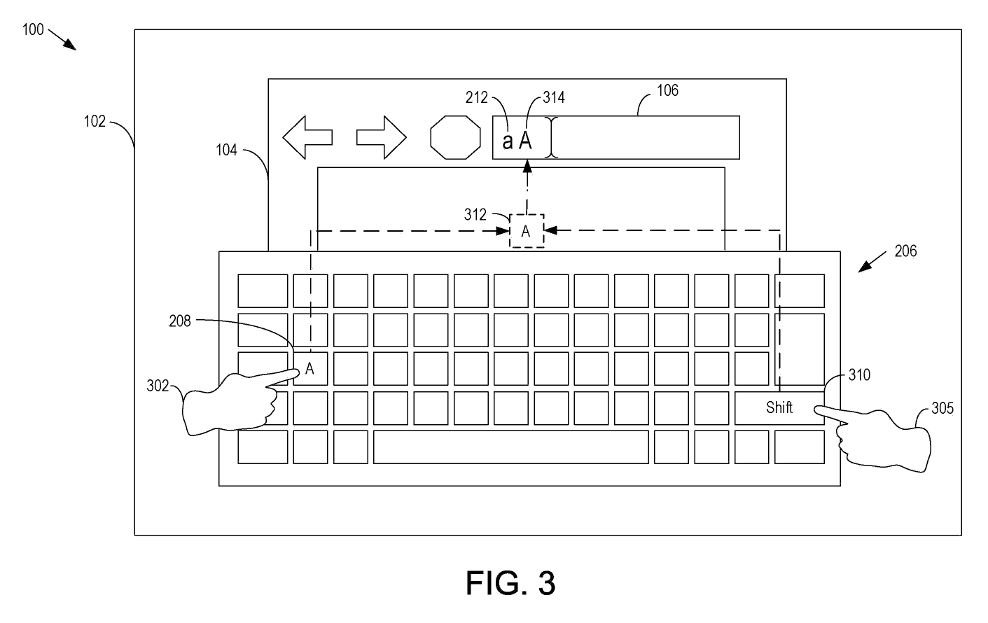

FIG. 3 shows a virtual keyboard image 206 that is receiving multi-touch input. As illustrated, virtual keyboard image 206 is receiving a touch input 302 at primary key 208 and is receiving a touch input 305 at modifier key 310. Furthermore, the touch input at primary key 208 and the touch input at modifier key 310 temporally overlap. In other words, the touch input at the primary key and the touch input at the modifier key overlap for a duration of time.

Multi-touch computing system 100 may translate the temporally overlapping touch inputs received at the primary key and the modifier key into a second keyboard message 312, different than first keyboard message 210. A keyboard output 314 may then be displayed at display surface 102 as a text character within text box 106 of application window image 104.

The modifier key can modify the keyboard message of the primary key such that second keyboard message 312 is different than first keyboard message 210 and correspondingly, that keyboard output 314 is different than keyboard output 212. In other words, the combination of the primary key and the modifier key can be translated into a keyboard message and/or keyboard output that neither the primary key nor the modifier key generate independently. As used herein, the second keyboard message may be the combination of two or more individual keyboard messages. For example, touch input at primary key 208 may individually create a keyboard message “A,” and touch input at modifier key 310 may individually create a keyboard message “B.” In some embodiments, temporally overlapping touch input at primary key 208 and modifier key 310 may collectively create a keyboard message “A+B,” while in other embodiments, a keyboard message “C” may be created responsive to the temporally overlapping touch input. Both keyboard messages “A+B” and “C” are different than keyboard message “A” alone. As a Nonlimiting example, the first keyboard message (e.g., “A”) may correspond with a lower case letter, and the second keyboard message (e.g., “A+B” or “C”) may correspond with an upper case letter.

Although shown as a combination of a letter key representing the primary key and a shift key representing the modifier key, a combination of two, three, or virtually any suitable number of temporally overlapping multi-touch inputs may also be processed by multi-touch computing system 100 to generate different keyboard messages and/or keyboard outputs. Also, in other embodiments, virtual keys other than a letter key and the shift key may be designated as the primary key or the modifier key. Nonlimiting examples of primary keys include letter keys, number keys, alphanumeric keys, command keys, system keys, and the like. Nonlimiting examples of modifier keys include shift keys, option keys, control keys, alt keys, function keys, and the like. In some embodiments, a virtual key may serve as a primary key in one key combination and as a modifier key in another key combination. Furthermore, in some embodiments, two or more modifier keys may be used to modify a primary key, with each additional modifier key resulting in a different keyboard message. For example, touch input at a primary key, a first modifier key, and a second modifier key can be translated into a third keyboard message, different than the first keyboard message and the second keyboard message. It should be understood that virtually any temporal combination of different key combinations can be used to generate different keyboard messages.

As a nonlimiting example, keyboards operating in foreign language modes can use different combinations of modifier keys with a common primary key to generate distinct characters. As an example, an “F” key may generate a first Japanese language character, an “F+Ctrl” key combination may generate a second Japanese language character, while an “F+Alt+Ctrl” key combination may generate a third Japanese language character.

Prior virtual keyboard technologies have not allowed for multiple temporally overlapping touch inputs to be combined into a keyboard message that can be the basis for the generation of a keyboard output that neither the primary key nor the modifier key generate independently. Rather, to create such a keyboard output, prior virtual keyboard technologies typically require that a first touch input to a first key is applied and released and that a second touch input to a second key is subsequently applied. Thus, current virtual keyboard technologies are not capable of processing multiple touch inputs that overlap for a duration of time. Prior technologies may therefore result in a less intuitive user experience and hence, virtual keyboard use that is less time efficient.

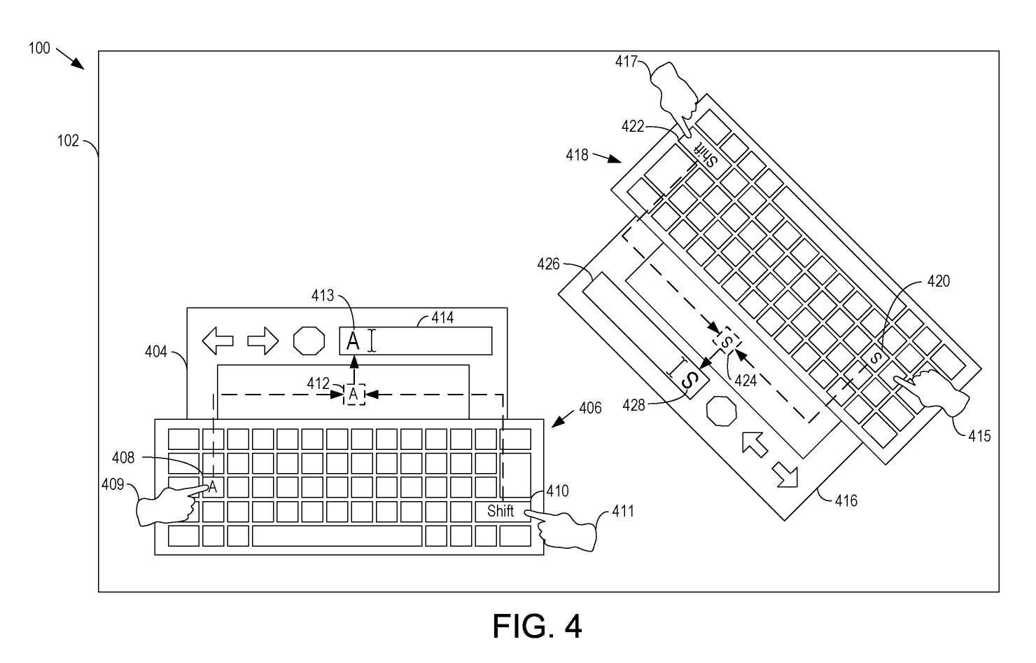

FIG. 4 shows application window image 404, application window image 416, virtual keyboard image 406, and virtual keyboard image 418, displayed at display surface 102 of multi-touch computing system 100. Each virtual keyboard image may be one of a plurality of different virtual keyboard images displayed at display surface 102. In the illustrated embodiment, each virtual keyboard image is receiving temporally overlapping touch inputs. Virtual keyboard image 406 is receiving a touch input 409 at primary key 408 and a temporally overlapping touch input 411 at modifier key 410. Multi-touch computing system 100 may translate the touch input received at the primary key and the modifier key into a keyboard message 412. A keyboard output 413 of keyboard message 412 may then be displayed at display surface 102 as a text character within text box 414 of application window image 404.

Similarly, virtual keyboard image 418 is receiving a touch input 415 at primary key 420 and a touch input 417 at modifier key 422. Furthermore, touch input 415 at primary key 420 and touch input 417 at modifier key 422 temporally overlap. Multi-touch computing system 100 may translate the touch input received at the primary key and the modifier key into a keyboard message 424. A keyboard output 428 of keyboard message 424 may then be displayed at display surface 102 as a text character within text box 426 of application window image 416.

Multiple touch inputs at virtual keyboard image 406 and virtual keyboard image 418 can be independently translated by multi-touch computing system 100 into different keyboard messages, keyboard message 412 and keyboard message 424, and into corresponding keyboard outputs, keyboard output 413 and keyboard output 428. Additionally, the touch inputs at an individual virtual keyboard image temporally overlap with each other and may temporally overlap with the touch inputs at another virtual keyboard image. Furthermore, each keyboard message may be received by different temporally overlapping applications. In this manner, two or more users can use the same multi-touch computing system to effectively operate two or more applications at the same time, and each application can receive fully functional multi-touch keyboard input. Furthermore, two or more different users may use two or more different virtual keyboard images to control the same application in some embodiments.

As illustrated in FIG. 4, virtual keyboard image 406 and virtual keyboard image 418 may be displayed at display surface 102 at multiple locations and orientations. A touch input received by a virtual keyboard image may result in the location and/or orientation of the virtual keyboard image being altered. Furthermore, the location and/or orientation of virtual keyboard images 406 and 418 may be changed at the same time. In some embodiments, the initial displaying of a virtual keyboard image may be based on an initial touch input to display surface 102 (i.e. in a location and orientation on display surface 102 that may allow for an ergonomic interface with the virtual keyboard image). For example, the location and angle of a finger swipe at text box 426 within application window 416 may cause multi-touch computing system 100 to display virtual keyboard image 418 as shown in FIG. 4

As an extension of the capacity to receive and process multiple touch inputs at a single virtual keyboard image, the capacity of multi-touch computing system 100 to receive and process multiple temporally overlapping touch inputs at more than one virtual keyboard image may allow for a more fluid and intuitive collaborative work experience for multiple system users. Efficiency of individual and collaborative work efforts may thus be improved.

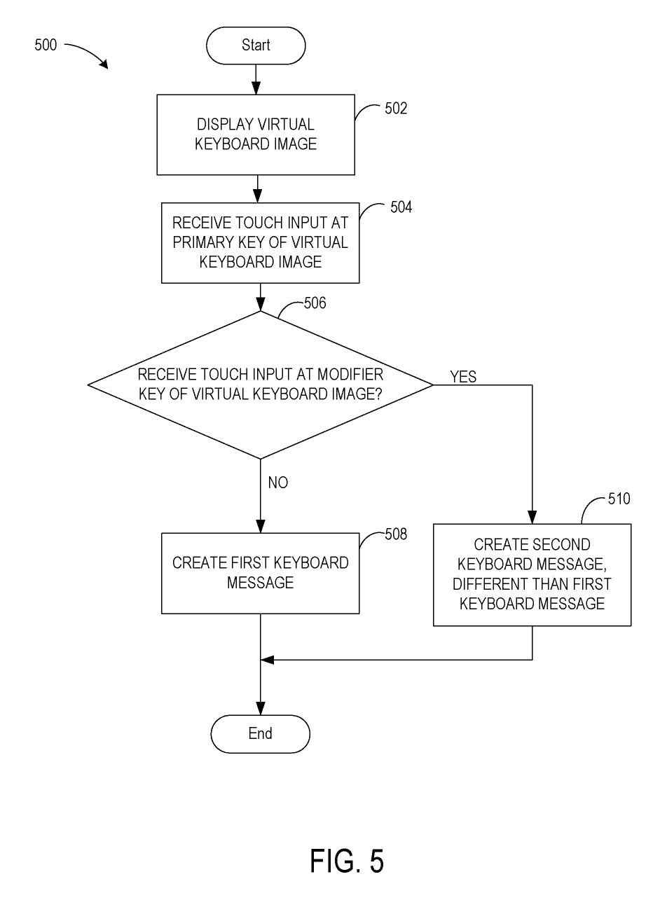

FIG. 5 shows a process flow of a method for receiving and processing multi-touch virtual keyboard input by a multi-touch computing system in accordance with an embodiment of the present disclosure. At 502, the method includes displaying a virtual keyboard image. As a non-limiting example, the multi-touch computing system may display a virtual keyboard image in response to touch input being received at a text box of an application window image. The virtual keyboard image may include a primary key and a modifier key.

At 504, touch input may be received by a primary key of the virtual keyboard image. At 506, it may be decided whether touch input is being received at a modifier key of the virtual keyboard image at the same time that touch input is being received by the primary key. If touch input at the modifier key is not being received at the same time that touch input is being received at the primary key, then a first keyboard message is created at 508. If touch input at the modifier key is being received at the same time that touch input is being received at the primary key, then a second keyboard message, different than the first keyboard message, is created at 510.

While the present disclosure uses a surface computing device as a non-limiting example of a multi-touch device capable of displaying a virtual keyboard, it should be understood that other multi-touch devices can be used in accordance with the present disclosure. It should be appreciated that the concepts disclosed herein may be implemented on any suitable touch-enabled display device that is capable of displaying a virtual keyboard and is also capable of processing two or more different user inputs having overlapping durations.

As used herein, the term “computing system” may include any system that electronically executes one or more programs. The embodiments described herein may be implemented on such a system, for example, via computer-executable instructions or code, such as system software or applications, stored on computer-readable media and executed by the computing system. Generally, such instructions include routines, objects, components, data structures, and the like that perform particular tasks or implement particular abstract data types.

The term “instructions” as used herein may connote a portion of a larger system or application, a single program, and/or multiple programs acting in concert, and may be used to denote applications, services, or any other type or class of logic executable by the computing system. Instructions can be implemented as software, firmware, or virtually any other form of executable logic. It should be appreciated that computer-readable media may include instructions which, upon execution by a processing subsystem, provide the virtual keyboard functionality described herein.

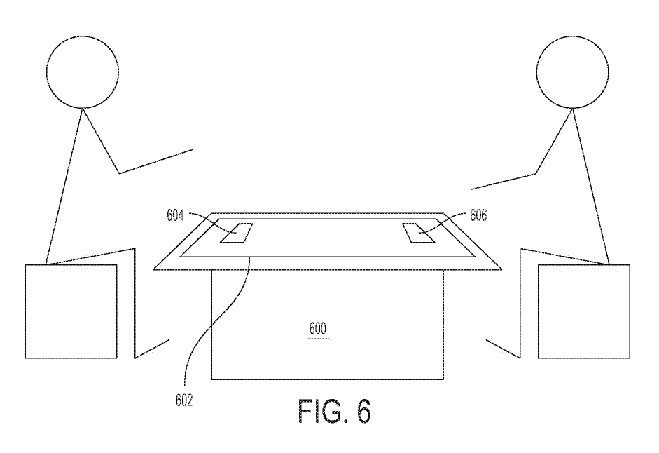

FIG. 6 shows an embodiment of a multi-touch surface computing system 600 according to the present disclosure. Multi-touch surface computing system 600 includes a horizontal, table-like, top surface having a touch-sensitive display surface 602. Display surface 602 may be capable of presenting visual information to one or more users.

Display surface 602 may also be capable of receiving input from one or more users. For example, the multi-touch surface computing system can recognize the touch of a user, and can translate the various ways in which a user touches the display surface into different commands. Additionally, the multi-touch surface computing system can recognize the touch of a user by visually monitoring the display surface with one or more optical sensors, as described below in more detail. In other embodiments, the display surface may include sensors configured for capacitive touch sensing, resistive touch sensing, and/or another type of touch sensing.

As shown in FIG. 6, multi-touch surface computing system 600 may display a plurality of virtual keyboard images at display surface 602. In this example, two virtual keyboard images are displayed at display surface 602: virtual keyboard image 604 and virtual keyboard image 606. In other embodiments, however, three, four, five, or another suitable number of virtual keyboards may be displayed at display surface 602, thus allowing for a collaborative virtual work environment for multiple system users. Furthermore, each instance of a virtual keyboard image may provide virtual keyboard functionality to a plurality of applications of the multi-touch surface computing system. This functionality may be provided to the plurality of applications via a shell, or other system component, or as a part of an individual application.

A portion of the instructions embodying the shell may optionally ensure that shell-level keyboard functionality is provided to only a single application at any given time (with regard to a single virtual keyboard image) and that a touch input received at display surface 602 (i.e. touch input at a text box within another open application window image) may allow keyboard functionality to be switched to another application.

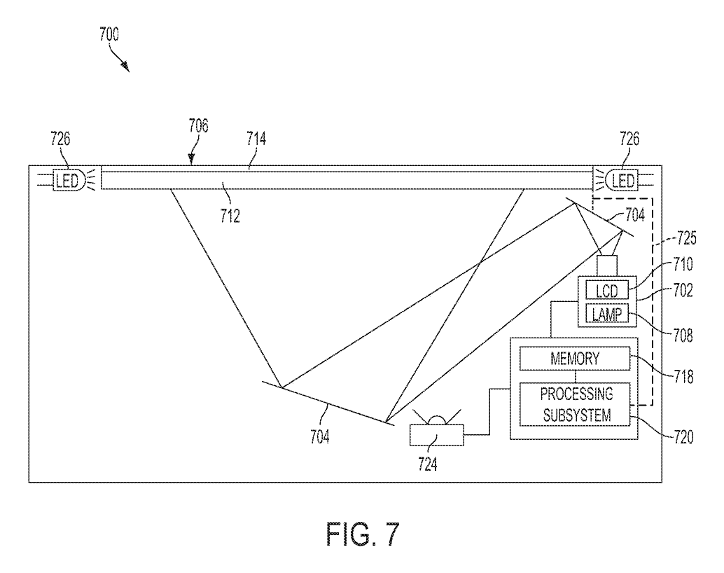

FIG. 7 shows a schematic depiction of an embodiment of a multi-touch surface computing system 700 utilizing an optical touch sensing mechanism. Multi-touch surface computing system 700 comprises an image generation subsystem 702 positioned to project display images on display surface 706, and optionally one or more mirrors 704 for increasing an optical path length and image size. Image generation subsystem 702 may include a light source 708 such as the depicted lamp that may be positioned to direct light at display surface 706. In other embodiments, light source 708 may be configured as an LED array, or other suitable light source. Image generation subsystem 702 may also include an image-producing element 710 such as the depicted LCD (liquid crystal display), an LCOS (liquid crystal on silicon) display, a DLP (digital light processing) display, or any other suitable image-producing element. Display surface 706 may include a clear, transparent portion 712, such as a sheet of glass, and a diffuser screen layer 714 disposed on top of the clear, transparent portion 712. In some embodiments, an additional transparent layer (not shown) may be disposed over diffuser screen layer 714 to provide a smooth look and feel to the display surface.

Multi-touch surface computing system 700 may include a reference light source 726. A pattern of reflection of the reference light emitted by reference light source 726 may change responsive to touch input on display surface 706. For example, light emitted by reference light source 726 may be reflected by a finger or other object used to apply touch input to display surface 706. The use of infrared LEDs as opposed to visible LEDs may help to avoid washing out the appearance of projected images on display surface 706.

Reference light source 726 may be positioned at any suitable location within multi-touch surface computing system 700. As illustrated in the depicted embodiment, reference light source 726 may be configured as multiple LEDs that are placed along a side of display surface 706. In this location, light from the LEDs can travel through display surface 706 via internal reflection, while some light can escape from display surface 706 for reflection by an object on the display surface 706. In alternative embodiments, one or more LEDs may be placed beneath display surface 706 so as to pass emitted light through display surface 706.

Multi-touch surface computing system 700 may further include a sensor 724 that may be configured to sense objects providing touch input to display surface 706. Sensor 724 may be configured to capture an image of the entire backside of display surface 706. Additionally, to help ensure that only objects that are touching display surface 706 are detected by sensor 724, diffuser screen layer 714 may help to avoid the imaging of objects that are not in contact with or positioned within a few millimeters of display surface 706.

Sensor 724 can be configured to detect the pattern of reflection of reference light emitted from reference light source 726. The sensor may include any suitable image sensing mechanism. Examples of suitable image sensing mechanisms include, but are not limited to, CCD and CMOS image sensors. Further, the image sensing mechanisms may capture images of display surface 706 at a sufficient frequency to detect motion of an object across display surface 706.

Sensor 724 may be configured to detect multiple touch inputs. Sensor 724 may also be configured to detect reflected or emitted energy of any suitable wavelength, including but not limited to infrared and visible wavelengths. To assist in detecting touch input received by display surface 706, sensor 724 may further include an additional reference light source 726 (i.e. an emitter such as one or more light emitting diodes (LEDs)) positioned to direct reference infrared or visible light at display surface 706.

Multi-touch surface computing system 700 may further include processing subsystem 720. Processing subsystem 720 may be operatively connected to image generation subsystem 702 and sensor 724. Processing subsystem 720 may receive signal data from sensor 724 representative of the pattern of reflection of the reference light at display surface 706. Correspondingly, processing subsystem 720, may process signal data received from sensor 724 and send commands to image generation subsystem 702 in response to the signal data received from sensor 724. Furthermore, as illustrated by dashed-line connection 725 between display surface 706 and processing subsystem 720, display surface 706 may alternatively or further include an optional capacitive, resistive, or other electromagnetic touch-sensing mechanism.

Multi-touch surface computing system 700 may further include memory 718 that may be operatively connected to processing subsystem 720. Memory 718 may include a variety of different types of computer-readable media. Non-limiting examples of computer-readable media include one or more hard disks, one or more random access memory modules, one or more read-only memory modules, and removable media such as compact disks, digital versatile disks, Flash drives, and the like. Memory 718 may further include instructions. A portion of the instructions of memory 718, when executed by processing subsystem 720, may cause image generation subsystem 702 to project a virtual keyboard image at display surface 706. The virtual keyboard image projected by the image generation subsystem may include a primary key and a modifier key.

The instructions of memory 718 may further include a portion that, when executed by processing subsystem 720, may translate the pattern of reflection created responsive to touch input at only the primary key into a first keyboard message. Similarly, the instructions may further include a portion that, when executed by processing subsystem 720, may translate the pattern of reflection of the reference light created when temporally overlapping multi-touch input is applied at the primary key and the modifier key into a second keyboard message that is different than the first keyboard message. Also, the instructions of memory 718 may further include a portion that, when executed by processing subsystem 720, may provide shell-level virtual keyboard functionality to a plurality of different applications of multi-touch surface computing system 700.

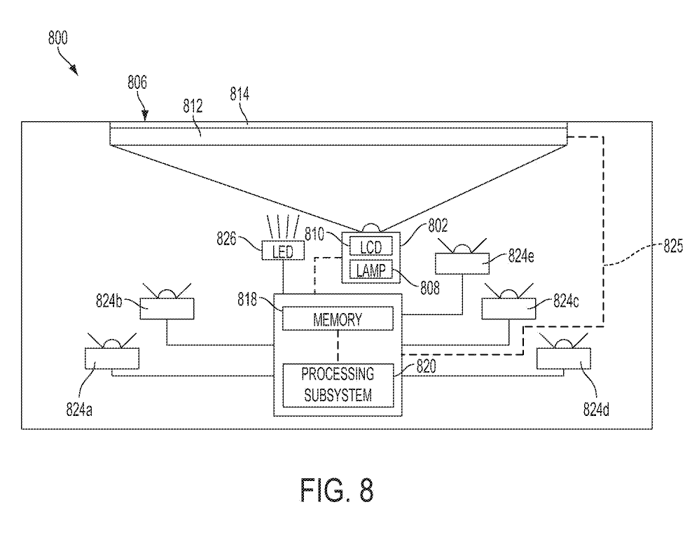

FIG. 8 shows a schematic depiction of another embodiment of a multi-touch surface computing system 800 that utilizes an optical touch sensing mechanism. Multi-touch surface computing system 800 may include an image generation subsystem 802 and a display surface 806. Image generation subsystem 802 may include a light source 808 such as the depicted lamp that may be positioned to display images at display surface 806. Image generation subsystem 802 may further include an image-producing element 810 such as the depicted LCD (liquid crystal display), an LCOS (liquid crystal on silicon) display, a DLP (digital light processing) display, or any other suitable image-producing element. Display surface 806 may include a transparent glass structure 812 and a diffuser screen layer 814 disposed thereon.

Multi-touch surface computing system 800 may include a processing subsystem 820. Processing subsystem 820 may be operatively connected to image generation subsystem 802. Multi-touch surface computing system 800 may further include a reference light source 826. As illustrated, reference light source 826 may be configured as an LED array positioned to direct reference light (i.e., reference infrared or visible light) at display surface 806. Multi-touch surface computing system 800 may further include sensors 824a-824e. Sensors 824a-824e may be operatively connected to processing subsystem 820 and may be configured to detect the pattern of reflection of reference light at display surface 806.

Sensors 824a-824e may each be configured to capture an image of a portion of display surface 806 (i.e. detect multi-touch input to display surface 806) and provide the image to processing subsystem 820. Processing subsystem 820 may assemble a composite image of the entire display surface 806 from the individual images captured by sensors 824a-824e. Sensors 824a-824d may be positioned generally beneath the corners of display surface 806, while sensor 824e may be positioned in a location such that it does not pick up glare from reference light source 826 that may be reflected by display surface 806 and picked up by sensors 824a-824d. In this manner, images from sensors 824a-824e may be combined by processing subsystem 820 to produce a complete, glare-free image of the backside of display surface 806. Additionally, display surface 806 may alternatively or further include an optional capacitive, resistive or other electromagnetic touch-sensing mechanism, as illustrated by a dashed-line connection 825 of display surface 806 with processing subsystem 820.

Multi-touch surface computing system 800 may further include memory 818 that may be operatively connected to processing subsystem 820, image generation subsystem 802, and sensors 828a-828e. Memory 818 may include a variety of different types of computer-readable media. Non-limiting examples of computer-readable media include one or more hard disks, one or more random access memory modules, one or more read-only memory modules, and removable media such as compact disks, digital versatile disks, Flash drives, and the like. The computer-readable media of memory 818 may further include instructions. A portion of the instructions of memory 818, when executed by processing subsystem 820, may cause image generation subsystem 802 to project a virtual keyboard image at display surface 806. The virtual keyboard may include a primary key and a modifier key.

The instructions of memory 818 may further include a portion that, when executed by processing subsystem 820, may translate the pattern of reflection created responsive to touch input at only the primary key into a first keyboard message. Similarly, the instructions may further include a portion that, when executed by processing subsystem 820, translate the pattern of reflection of reference light created when temporally overlapping multi-touch input is received at the primary key and the modifier key into a second keyboard message that is different than the first keyboard message. Also, the instructions of memory 818 may further include a portion that, when executed by processing subsystem 820, provides shell-level virtual keyboard functionality to a plurality of different applications of multi-touch surface computing system 800.

It should be appreciated that the configurations and/or approaches described herein are exemplary in nature, and that these specific embodiments or examples are not to be considered in a limiting sense, because numerous variations are possible. For example, while described herein in the context of a multi-touch surface computing system having a horizontal, table-like display surface, it may be appreciated that the concepts described herein may also be used with display surfaces of any other suitable size and/or orientation, including vertically arranged display surfaces.

Furthermore, the specific routines or methods described herein may represent one or more of any number of processing strategies such as event-driven, interrupt-driven, multi-tasking, multi-threading, and the like. As such, various acts illustrated may be performed in the sequence illustrated, in parallel, or in some cases omitted. Likewise, the order of any of the above-described processes is not necessarily required to achieve the features and/or results of the exemplary embodiments described herein, but is provided for ease of illustration and description.

The subject matter of the present disclosure includes all novel and nonobvious combinations and subcombinations of the various processes, systems and configurations, and other features, functions, acts, and/or properties disclosed herein, as well as any and all equivalents thereof.

1. A multi-touch surface computing system, comprising:
a display surface;
an image generation subsystem positioned to project display images on the display surface;
a reference light source positioned to direct reference light at the display surface, wherein a pattern of reflection of the reference light changes responsive to touch input on the display surface;
a sensor to detect the pattern of reflection;
a processing subsystem operatively connected to the image generation subsystem and the sensor;
computer-readable media operatively connected to the processing subsystem and including instructions that, when executed by the processing subsystem, cause the image generation subsystem to project a virtual keyboard image on the display surface, the virtual keyboard image including a primary key and a modifier key;
the computer-readable media further including instructions that, when executed by the processing subsystem, translate the pattern of reflection created responsive to touch input at only the primary key into a first keyboard message; and
the computer-readable media further including instructions that, when executed by the processing subsystem, translate the pattern of reflection created responsive to touch input at both the primary key and the modifier key into a second keyboard message, different than the first keyboard message.

2. The multi-touch surface computing system of claim 1, wherein the virtual keyboard image is one of a plurality of different virtual keyboard images projected by the image generation subsystem on the display surface.

3. The multi-touch surface computing system of claim 2, wherein touch input at each virtual keyboard image is independently translated into a different keyboard message, and wherein each different keyboard message is delivered to different temporally overlapping applications.

4. The multi-touch surface computing system of claim 2, wherein touch input at each virtual keyboard image is independently translated into a different keyboard message, and wherein each different keyboard message is delivered to a same application.

5. The multi-touch surface computing system of claim 1, wherein the computer-readable media further includes instructions that, when executed by the processing subsystem, provide shell-level virtual keyboard functionality to a plurality of different applications of the multi-touch surface computing system.

6. The multi-touch surface computing system of claim 1, wherein the instructions translate the pattern of reflection created responsive to touch input at both the primary key and the modifier key into a second keyboard message when the touch input at the primary key and the touch input at the modifier key temporally overlap.

7. The multi-touch surface computing system of claim 1, wherein the virtual keyboard image overlays an application window image.

8. The multi-touch surface computing system of claim 1, wherein the virtual keyboard image further includes a second modifier key, and wherein the computer-readable media further includes instructions that, when executed by the processing subsystem, translate a pattern of reflection created responsive to touch input at the primary key, the modifier key, and the second modifier key into a third keyboard message, different than the first keyboard message and the second keyboard message.

9. The multi-touch surface computing system of claim 1, wherein the primary key is an alphanumeric key, the modifier key is a shift key, the first keyboard message corresponds to a lower case letter, and the second keyboard message corresponds to an upper case letter.

10. A computing system, comprising:
a display;
a sensor to detect multi-touch input at the display;
a processing subsystem operatively connected to the display and the sensor;
computer-readable media operatively connected to the processing subsystem and including instructions that, when executed by the processing subsystem, cause the display to present a virtual keyboard image, the virtual keyboard image including a primary key and a modifier key;
the computer-readable media further including instructions that, when executed by the processing subsystem, translate touch input at only the primary key into a first keyboard message; and
the computer-readable media further including instructions that, when executed by the processing subsystem, translate temporally overlapping touch input at both the primary key and the modifier key into a second keyboard message, different than the first keyboard message.

11. The computing system of claim 10, wherein the virtual keyboard image is one of a plurality of different virtual keyboard images displayed at the display.

12. The computing system of claim 11, wherein touch input at each virtual keyboard image is translated into a different keyboard message, and wherein each different keyboard message is delivered to different temporally overlapping applications.

13. The computing system of claim 10, wherein the computer-readable media further includes instructions that, when executed by the processing subsystem, provide shell-level virtual keyboard functionality to a plurality of different applications of the computing system.

14. The computing system of claim 10, wherein the virtual keyboard image overlays an application window image.

15. A method of receiving user input with a multi-touch surface computing system, comprising:
displaying a virtual keyboard image at a display, the virtual keyboard including a primary key and a modifier key;
creating a first keyboard message in response to touch input at only the primary key; and
creating a second keyboard message, different than the first keyboard message, in response to touch input at both the primary key and the modifier key.

16. The method of claim 15, wherein the virtual keyboard image is a first virtual keyboard image, and wherein the method further comprises displaying a second virtual keyboard image at the display.

17. The method of claim 16, further comprising creating separate keyboard messages in response to touch input at the first virtual keyboard image and in response to touch input at the second virtual keyboard image.

18. The method of claim 15, further comprising providing virtual keyboard functionality to a plurality of applications.

19. The method of claim 15, further comprising creating the second keyboard message when the touch input at the primary key and the touch input at the modifier key temporally overlap.

20. The method of claim 15, further comprising overlaying the virtual keyboard image over an application window image.
